(19) United States
(12) Patent Application Publication
(10) Pub. No.: US 2012/0085611 A1
(43) Pub. Date: Apr. 12, 2012

(54) ENERGY RECOVERY SYSTEM

(75) Inventor: Imad Mahawili, Napa, CA (US)

(73) Assignee: ENERGY RECOVERY TECHNOLOGY, LLC, Napa, CA (US)

(21) Appl. No.: 13/327,796

(22) Filed: Dec. 16, 2011

Related U.S. Application Data
(63) Continuation of application No. 12/248,553, filed on Oct. 9, 2008.
Application No. 12/248,553 is a continuation-in-part of application No. 12/059,433, filed on Mar. 31, 2008, now abandoned.
Application No. 12/059,433 is a continuation of application No. 10/880,690, filed on Jun. 30, 2004, now abandoned.

(51) Int. Cl. B60L 9/00; B61D 43/00

(52) U.S. Cl. 191/10; 290/3

(57) ABSTRACT

An energy recovery system including a device that produces a magnetic field adapted for mounting to a vehicle and a stationary conductor adapted for placing in or adjacent the path of the vehicle wherein the magnetic field induces current to flow through the conductor when the vehicle moves past the conductor. The vehicle may be an automobile, a truck, a train, or other type of vehicle. When used in conjunction with a train, the energy recovery system may be designed to recover energy from non-locomotive train cars in addition to, or in lieu of, the train locomotive. Kinetic energy that would otherwise be lost to heat energy through the application of brakes to the non-locomotive cars can thereby be recovered and re-used.

### CROSS-REFERENCE TO RELATED APPLICATIONS

This application is a continuation application of U.S. patent application Ser. No. 12/248,553 filed Oct. 9, 2008 by Imad Mahawili and entitled ENERGY RECOVERY SYSTEM, which is a continuation-in-part application of U.S. patent application Ser. No. 12/059,433 filed Mar. 31, 2008 by Imad Mahawili and entitled ENERGY RECOVERY SYSTEM, which in turn is a continuation of U.S. patent application Ser. No. 10/880,690 filed on Jun. 30, 2004 by Imad Mahawili and entitled ENERGY RECOVERY SYSTEM, the complete disclosures of both of which are hereby incorporated herein by reference.

### TECHNICAL FIELD AND BACKGROUND OF THE INVENTION

The present invention relates to a system that recovers energy from a moving object, such as a vehicle.

Energy consumption of non-renewable resources and the pollution created by this energy consumption, as well as pollution created when energy is generated, has long been a concern. Efforts to curb consumption of non-renewable energy sources and to reduce pollution, for example in vehicles, has led to the development of electric and/or hybrid vehicles. While electric and hybrid vehicles have reduced the consumption of some non-renewal resources and generate less pollution, the use of electric vehicles, which require recharging, simply shifts or reallocates the location of the pollution between vehicles and power plants—typically coal fired power plants—and, further, shifts at least some of the energy consumption from one non-renewable source to another non-renewable source—such as from gasoline to coal. However, the total amount of energy consumed by both types of vehicles has remained generally unchanged.

While great strides have been made to increase the energy efficiency of vehicles, there are still inherent energy inefficiencies and waste that are not currently addressed. For example, when a vehicle is driven up a hill or an incline and thereafter descends with the engine running, energy is wasted because it is not recoverable at present.

Consequently, there is a need for a system that can recover wasted energy, such as from a vehicle, and further that can covert the wasted energy into a source of useable energy for immediate or later use.

### SUMMARY OF THE INVENTION

Accordingly, the present invention provides an energy recovery system that recovers energy from a moving object, such as a vehicle, which can be used or stored for later use.

In one form of the invention, an energy recovery system includes a device that produces a magnetic field, which is adapted for mounting to a vehicle, such as an automobile, a train, or the like, and a stationary conductor that is adapted for placing in or adjacent the path of the vehicle such that the magnetic field induces current to flow through the conductor when the vehicle moves past the conductor, which is harnessed and stored for immediate or later use.

In another aspect of the invention, a train car is provided that includes a vehicle frame having first and second bogies. The first bogie is positioned near a first end of the vehicle frame and attached to its underside. The second bogie is positioned near a second end of the vehicle frame and also attached to its underside. A device is positioned underneath the vehicle frame that is adapted to generate a magnetic field. A controller is also provided on the train car that is adapted to activate the device such that the magnetic field generated by the device intersects with a conductor positioned off-board the train car and induces a voltage in the conductor, thereby converting a portion of the train car's kinetic energy to electrical current that flows through the conductor.

In another aspect of the invention, a train system is provided that includes a non-locomotive train car, a track having a rail, and a coil positioned adjacent the rail. The non-locomotive train car includes a device attached to it that is adapted to generate a magnetic field. A controller is also provided that is adapted to activate the device such that the magnetic field generated by the device intersects with the coil and induces a voltage in the coil, thereby converting a portion of the train car's kinetic energy to electrical current that flows through the coil.

In still another aspect of the invention, a method is provided for recovering energy from a train. The method includes providing a regenerative brake on a non-locomotive train car and using the regenerative brake to convert kinetic energy of the non-locomotive train car to electrical energy.

In other aspects of the invention, the device may include a permanent magnet and/or a coil that is activated by the controller by being physically moved to a position nearer to the conductor and/or coil that is positioned off-board the vehicle. The device may also include a coil wherein the activation of the coil includes feeding an electrical current through the coil. The device may be attached to one of the train car's bogies, along with another such device attached to an opposite side of the bogie. An additional two more devices may be attached to another one of the train car's bogies, and all of the devices may be simultaneously activated by the controller. The controller may receive a control signal from a different train car, such as the locomotive, that indicates a degree to which the device or devices should be activated. In response to an increasing degree specified in the control signal, the controller may either move the device closer to the off-board conductor, increase an electrical current flowing through a coil contained within the device, or both. The system may include a plurality of rails and the conductor may comprise a plurality of coils positioned adjacent the plurality of rails. The conductor may be positioned on an incline such that a train car traveling down the incline has its kinetic energy converted to electrical energy that may be used to power a different train going up the incline on a neighboring track, thereby creating a sort of electromagnetic version of a funicular train. The method of recovering energy from the train may involve positioning a portion of the regenerative brake off-board the vehicle and another portion on-board, or it may involve positioning both portions on-board the vehicle.

Accordingly, it can be understood that various aspects of the present invention allow for the recovery of energy from moving vehicles, such as train cars, which may otherwise be wasted energy. Further, such recovered energy may be transferred to an energy supply for immediate or later use. In the case of trains, the recovered energy may come from the non-locomotive train cars, as well as the locomotive. By applying the system to non-locomotive train cars, either in addition to or in lieu of the locomotive, the kinetic energy of substantially the entire train may be recovered, thereby greatly improving the energy recovery of prior train systems that have limited their energy recovery to the locomotive train cars.

These and other objects, advantages, purposes, and features of the invention will become more apparent from the study of the following description taken in conjunction with the drawings.

### DETAILED DESCRIPTION OF THE DRAWINGS

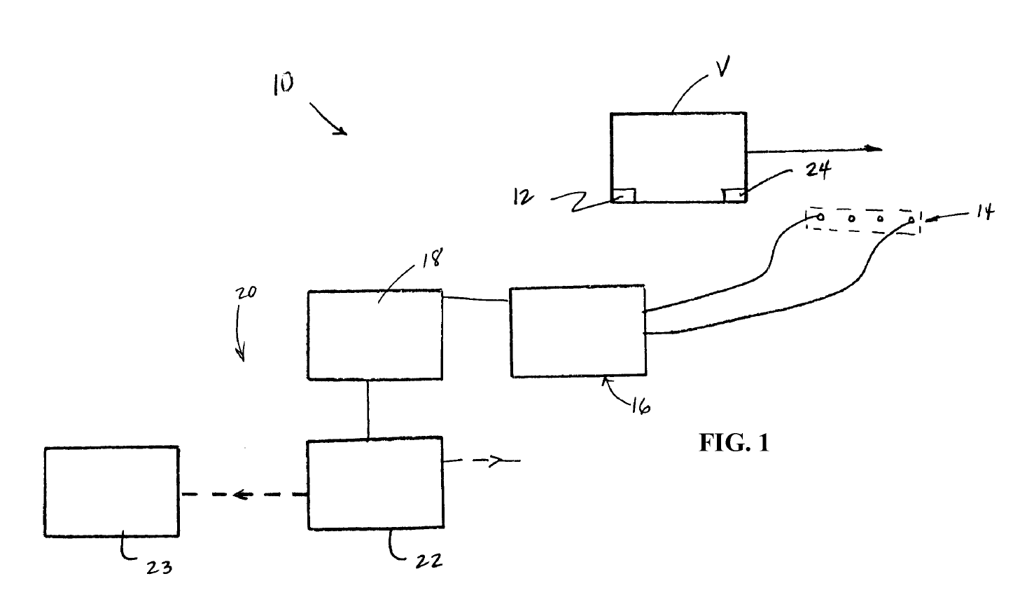

FIG. 1 is a schematic drawing of the energy recovery system of the present invention;

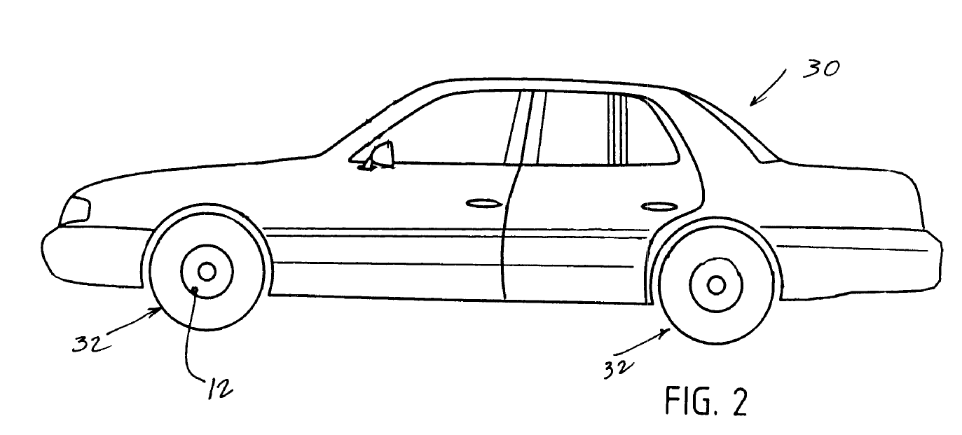

FIG. 2 is a schematic view of the mounting of an electromagnetic field generator to a vehicle;

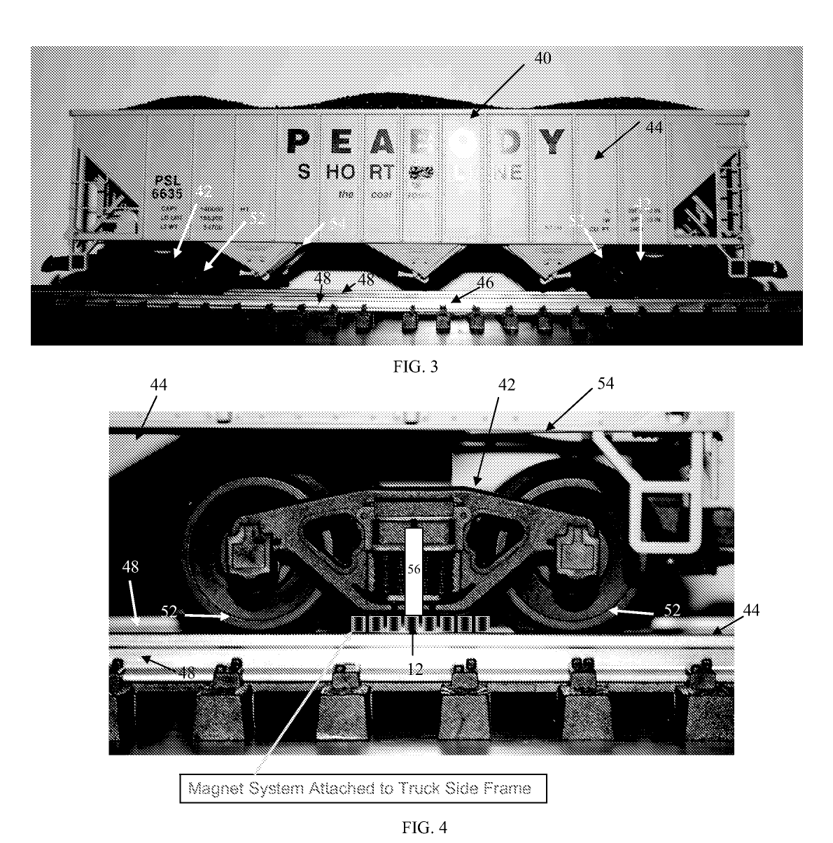

FIG. 3 is a side elevational view of a train car to which one or more aspects of the present invention may be applied;

FIG. 4 is a close-up, side elevational view of a train bogie to which a rotor is attached;

FIG. 5 is a close-up, side elevational view of the train bogie of FIG. 4 shown moved to a position on the train track where a stator system is positioned;

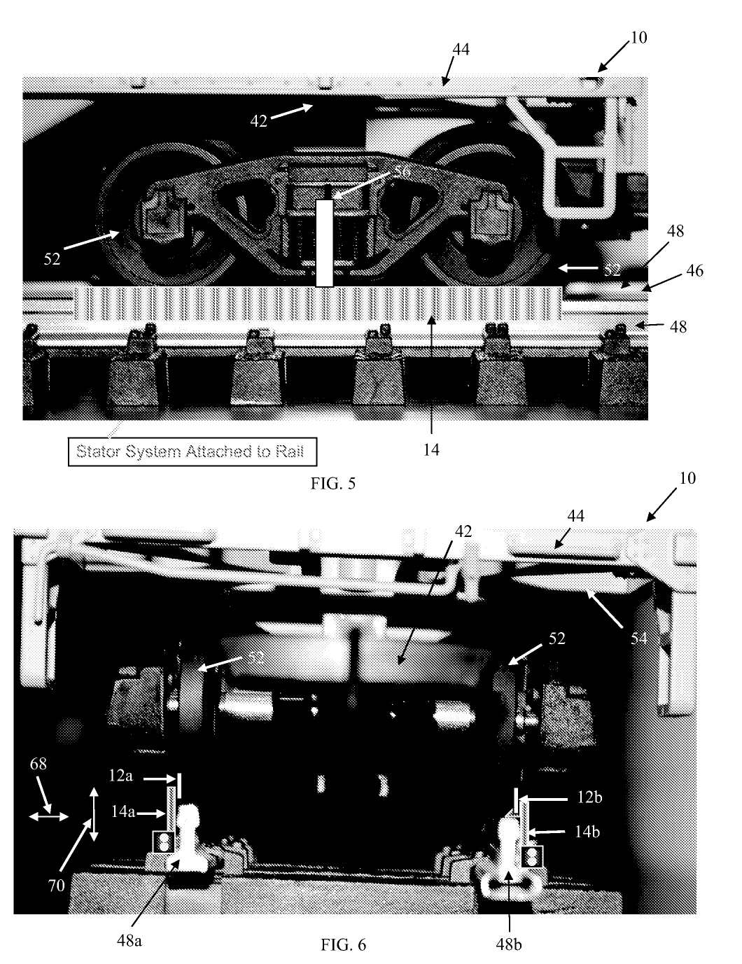

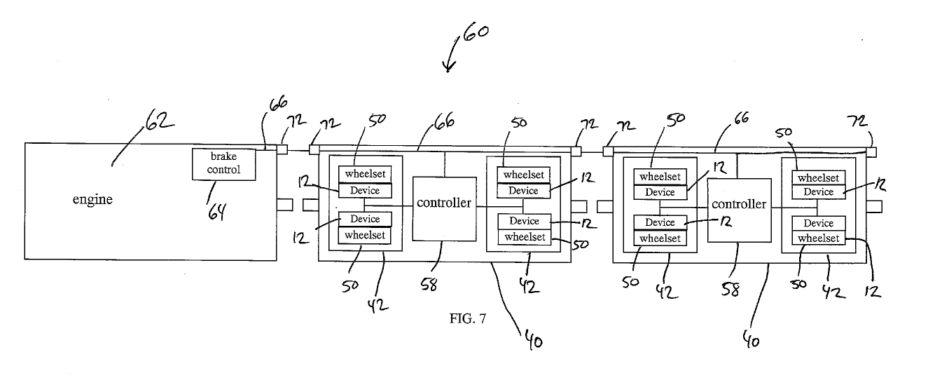

FIG. 6 is a front, elevational view of the train bogie of FIG. 5; and

FIG. 7 is a schematic diagram of a train, including a train locomotive and a plurality of non-locomotive train cars.

### DETAILED DESCRIPTION OF THE EMBODIMENTS

Referring to FIG. 1, the numeral 10 generally designates an energy recovery system according to one embodiment of the present invention. As will be more fully described below, energy recovery system 10 uses the motion of a moving object to generate energy and/or resources that can be used immediately or stored for later use and, further, can optionally be delivered to a location remote from the object. For ease of description, hereinafter reference will be made to a vehicle as the moving object. However, it should be understood that the present invention is not so limited.

Energy recovery system 10 includes a magnetic field generating device 12, a conductor 14, such as a bundle of electrically conductive wires, that forms a closed loop circuit, and an energy storage device 16, such as a battery or a capacitor, which stores the energy generated by the current flowing through the circuit. Magnetic field generator 12 may comprise a permanent magnet or an electromagnet and is mounted to vehicle V, such as a car, an SUV, a truck, a bus, a train, or the like. For example, magnetic field generator 12 may comprise a permanent magnet commercially fabricated from such materials as sintered and bonded Neodymium iron boron, or samarium cobalt, or alnico, or ceramics. The dimensions of the magnet depend on the vehicle size and the ultimate magnetic field strength desired at the conductor surface. One example is a permanent magnet of sintered and bonded Neodymium alloy that is 5.75 inches in width and a square cross sectional dimension of 1.93 inches by 1.93 inches. This permanent magnet example can deliver a field strength of approximately 2300 Gauss at a distance of one inch from its 5.75 inch surface facing the conductor. Higher magnetic strength permanent magnets can be designed but this field strength can generate approximately 10 amps of current at 120 volts A.C. in some alternating conductor circuit designs at vehicle speeds around 25 miles per hour.

Conductor 14 is located in the path of the vehicle so that when magnetic field generator 12 passes by conductor 14, current flow is induced in the conductor, which is transmitted to energy storage device 16 for storage and later use, as will be more fully described below. As mentioned above, conductor circuits can be designed with a variety of objectives with respect to current and voltage generation. But basically they are either alternating or direct current circuits. The final conductor design will depend on the specific voltage and current desired and the method of storage and use of the generated electricity. For example, when hydrogen generation is desired then the desired conductor design should be direct current whereas for direct lighting an alternating current conductor circuit might be considered. In some embodiments, conductor 14 may include, or may take the form of, a circuit sheet, such as that disclosed in commonly-owned U.S. patent application Ser. No. 11/828,686 entitled CIRCUIT MODULE filed Jul. 26, 2007 by applicant Imad Mahawili, the complete disclosure of which is hereby incorporated herein by reference.

As generally noted above, magnetic field generator 12 is mounted to the vehicle so that when the vehicle is traveling and travels across or by conductor 14, magnetic field generator 12 will induce current flow in conductor 14. According to Faraday's Law of Induction, when a magnet or conductor moves relative to the other, for example when a conductor is moved across a magnetic field, a current is caused to circulate in the conductor. Furthermore, when the magnetic force increases or decreases, it produces electricity; the faster it increases or decreases, the more electricity it produces. In other words, the voltage induced in a conductor is proportional to the rate of change of the magnetic flux. In addition, based on Faraday's laws and Maxwell's equations, the faster the magnetic field is changing, the larger the voltage that will be induced. Therefore, the faster the vehicle moves past conductor 14, the greater the current flow and, hence, the greater amount of energy stored in storage device 16.

As is known from Lenz' law, when a current flow is induced in conductor 14 it creates a magnetic field in conductor 14, which opposes the change in the external magnetic field, produced by magnetic field generator 12. As a result, the forward motion of the vehicle will be slowed; though the degree to which the forward motion will be slowed will vary depending on the magnitude of the respective fields. In keeping with the goal to recover energy, therefore, conductor 14 may be located along the path of vehicle where the vehicle is the most inefficient (i.e. where the vehicle wastes energy) and also where the vehicle has the greatest speed. For example, conductor 14 may be located at a decline, such as on the downhill side of a hill or of a mountain or the like, where the vehicle's speed will increase under the force of gravity over the engine induced speed. On a decline where the speed of the vehicle has increased due to the force of gravity, drivers will often apply their brakes to slow the vehicle to maintain their speed within the speed limit. Ordinarily, the vehicle's engine will run continuously, thus wasting energy, which energy in the present system is recovered. Provided that the reduction in the speed of the vehicle due to the interaction between the two magnetic fields does not exceed the corresponding increase in speed due to gravity, the recovery of energy from the vehicle does not increase the energy consumed by the vehicle. Hence, energy that would otherwise be wasted is recovered from the vehicle. Though it should be understood that the conductor may be positioned at other locations along the path of the vehicle, including locations where the vehicles must begin braking or begin slowing down.

As noted above, conductor 14 may comprises a bundle of electrically conductive wires, which are placed in the path (or adjacent the path) of the vehicle. In one embodiment, the wires are extended across the path, for example, across the roadway generally orthogonal to the direction of travel of the vehicle, so that the vehicle passes over the bundle of wires. The wires may also be incorporated below the road surface of the roadway. For example, the wires may be recessed or embedded in the roadway surface and, further, optionally encapsulated in a body that is recessed or embedded in the roadway. The material forming the body for encapsulating the wires may be a non-conductive and/or non-magnetic material, such plastic or rubber or the like, to insulate the wires and to protect the wires from the elements, and road debris.

Referring again to FIG. 1, energy storage device 16 is coupled to a control system 18, which monitors and/or detects when energy storage device 16 has reached or exceeded a threshold level of stored energy. Control system 18 may be configured to transfer energy from storage energy device 16 when the energy level in storage device 16 has reached the threshold level and, further, to transfer the energy to a transmission system or an energy conversion system or the like, where the transferred energy can be used as a supply of energy or to generate resources for some purpose other than driving the vehicle.

For example, control system 18 may transfer the energy to an energy conversion system 20 to transform the energy into another resource, such as a supply of oxygen, hydrogen, or other consumable products. Furthermore, one or more of these products may in turn be used to generate more energy as noted below. In the illustrated embodiment energy conversion system 20 includes an electrolysis system 22 that uses the transferred energy to convert, for example, water into oxygen and hydrogen, which oxygen may be forwarded on to laboratories or hospitals or the like. As noted above, the hydrogen may be used for energy generation. Hydrogen may be used as fuel and an energy supply, including to power vehicles, run turbines or fuel cells, which produce electricity, and to generate heat and electricity for buildings. In the illustrated embodiment, the hydrogen is used to run hydrogen fuel cells 23, which convert hydrogen and oxygen into electricity and can be used to power other vehicles or to provide electricity and heat to buildings. Hence, the current flow in conductor 14 may be used to generate energy and/or to produce products.

As noted above, magnetic field generator 12 may comprise a permanent magnet or an electromagnet. When employing an electromagnet, the magnetic field may be selectively actuated. For example, the vehicle may include a control for actuating the electromagnet. Further, energy recovery system 10 may include a sensor 24 that generates a signal to the vehicle control when the sensor detects that the vehicle is in proximity to conductor 14 so as to trigger the control to actuate the electromagnet. Sensor 24 may be mounted to the vehicle or may be mounted at or near the conductor. Further examples of sensor and switching arrangements that may be used are disclosed in commonly-owned U.S. patent application Ser. No. 61/014,175 entitled METHOD OF ELECTRIC ENERGY TRANSFER BETWEEN A VEHICLE AND A STATIONARY COLLECTOR filed Dec. 17, 2007 by Imad Mahawili, as well as commonly-owned U.S. patent application Ser. No. 11/454,948 entitled ENERGY RECOVERY SYSTEM filed Jun. 16, 2006 by Imad Mahawili, the complete disclosures of which are both hereby incorporated herein by reference.

Referring to FIG. 2, the numeral 30 generally designates a vehicle. Although vehicle 30 is illustrated as an automobile, it should be understood that the term vehicle as used herein is used in its broadest sense to cover any means to carry or transport an object and includes trains, buses, trucks, or the like. As noted above, the faster the speed of the magnetic field generator 12, the greater the rate of energy generation. In the illustrated embodiment, magnetic field generator 12 is mounted to a wheel device 32 of vehicle 30. Alternately, the magnetic field generator 12 may be mounted to a flywheel or the like, for example, that is driven by the vehicle engine.

In one embodiment, either the north (N) or south (S) poles of the magnetic field generator 12 are facing outwardly from the center of the wheel device, so that the poles would be traveling at a higher speed than if mounted at a fixed location on the vehicle. Thus, when the vehicle drives over or adjacent the conductor (14), the rate of rotation of the magnetic field generator 12 would significantly increase the rate of electricity generation per pass over or adjacent the conductor. This same increased energy generation can be used with the magnetic field generator being mounted to a train wheel device.

Furthermore, the rotating magnetic field generator 12 may also comprise a cylindrical structure formed from a plurality of permanent magnets, with one pole oriented towards the perimeter of the cylindrical-shaped member and the other pole being oriented towards the center of the cylindrical-shaped member. This will ensure conservation of Lens' law for induced current directionality within the conductor.

In addition, multiple magnetic field generators may be used in any of the aforementioned applications to thereby further enhance the energy recovery. For example, when this system is employed on a train, each train car could include one or more magnetic field generators so that as each car passes the conductor or conductors, which may be located near the track, energy can be generated from each magnetic field generator.

One example of a train car 40 that may incorporate aspects of energy recovery system 10 is illustrated in FIG. 3. Train car 40, which is a non-locomotive train car, includes a pair of bogies 42 on which a vehicle frame 44 is supported. Bogies 42 each support a pair of wheelsets 50. Wheelsets 50, in turn, each support a pair of wheels 52. Train car 40 travels on a train track 46 that includes two rails 48 (FIG. 6), although it will be understood that the principles of energy recovery system 10 may be applied to trains that travel on monorails, as well as trains that travel with more than two rails.

As illustrated in FIG. 4, at least one bogie on train car 40 includes a magnetic field generating device 12. Magnetic field generating device 12 may alternatively be referred to as a rotor. Magnetic field generating device 12 is illustrated in FIG. 4 as being attached to, and supported by, one of bogies 42. It will, of course, be understood that magnetic field generating device 12 may be positioned at locations on train car 40 other than that shown in FIG. 4, including, but not limited to, an underside 54 of vehicle frame 44, different positions on bogie 42, and others. Magnetic field generating device 12 may comprise one or more permanent magnets, one or more coils of wire that generate a magnetic field when an electrical current passes therethrough, or a combination of coils with permanent magnetic cores. Magnetic field generating device 12 is shown attached to a moveable arm 56 that allows device 12 to physically move in a manner that will be described more below.

In the embodiment of energy recovery system 10 depicted in FIG. 5, a conductor 14, which may also be referred to as a stator, is positioned along various portions of railroad track 46. Conductor 14 comprises at least one coil that is oriented in a manner with respect to magnetic field generating device 12 such that, when magnetic field generating device 12 is activated in a manner to be described more below, the magnetic field from device 12 intersects the coil of conductor 14 in a manner so as to induce a voltage within conductor 14. Conductor 14 is adapted to allow this induced voltage to create an electrical current. While not illustrated in FIG. 5, the electrical current within conductor 14 may be transmitted by any suitable means to energy storage device 16.

Magnetic field generating device 12 and conductor 14 thereby interact with each other in a manner that causes electrical energy to be inductively generated off-board train car 40. Stated alternatively, magnetic field generating device 12 and conductor 14 act in concert to convert at least a portion of the kinetic energy of train car 40 to electrical energy. This electrical energy may then be stored in energy storage device 16 or immediately used for other purposes. The result of the conversion of the kinetic energy of train car 40 to electrical energy is typically a reduction in the speed of train car 40, or a reduced or eliminated acceleration of train car 40 (such as when train car 40 is moving down an incline). The interaction of magnetic field generating device 12 and conductor 14 therefore acts as a regenerative brake.

While conventional regenerative braking typically takes place within the confines of an electrical motor that provides motive power to a vehicle and then, in braking situations, reverses its role of a motor to become a generator, the design of magnetic field generating device 12 and conductor 14 is such that they need not ever be used as a means for providing locomotion to train car 40. However, it will be understood by those skilled in the art that device 12 and conductor 14 could be utilized to either provide locomotive power to train car 40 or to transfer electrical energy to train car 40 for usage on-board. One of the advantages of energy recovery system 10 when practiced in the embodiment depicted in FIG. 5, as well as variations thereof, is that the kinetic energy of the non-locomotive cars can be recovered during braking of the train. In conventional trains, the non-locomotive cars are braked using brakes that physically engage either the wheels, a brake drum that spins with the wheels, or some other structure that rotates in association with the wheels. This physical engagement creates friction that slows down the rotational movement, thereby causing braking of the train car. The kinetic energy of the train car, however, is converted to heat energy with such physical brakes, and that heat energy is lost.

In the embodiments of the energy recovery system 10 of the present invention wherein device 12 and conductor 14 act as regenerative brakes on one or more non-locomotive train cars 40, it is possible to recover substantially more energy that would otherwise be lost during braking in a conventional train. Further, by transferring the recovered electrical energy off-board the vehicle, it is possible to save and/or use virtually all of the recovered energy. In contrast, some conventional regenerative braking systems on the locomotive cars of trains include large scale resistors that convert any excess electrical energy above and beyond the current on-board needs of the train to heat energy, thereby wasting the recovered energy. Energy recovery system 10, however, need not waste any of the recovered energy because energy storage device 16 may be constructed to handle, store, and/or transfer all of the electrical energy that is generated in conductor 14.

As can be seen more clearly in FIG. 6, energy recovery system 10, when applied to trains, may include a plurality of conductors 14 with a first one positioned adjacent to a first rail 48a and a second one positioned adjacent to a second rail 48b, wherein first rail 48a is positioned opposite to second rail 48b. Further, train car 40 may be constructed to include a pair of magnetic field generating devices 12a and 12b, with a first one positioned along a first side of train car 40 and a second positioned along an opposite side of train car 40. As shown in FIG. 6, magnetic field generating device 12a is positioned to generate an electrical current within conductor 14a, while magnetic field generating device 12b is positioned to generate an electrical current with in conductor 14b. Both devices 12a and 12b may be attached to and/or supported by bogie 42. Further, additional devices 12 may be attached to the other one (or more) bogies 42 on train car 40, such that a train car 40 having two bogies 42 may include four magnetic field generating devices 12 (two on each side of each bogie 42).

As mentioned, conductors 14 may be positioned adjacent rails 48. Conductors 14 may be constructed in shapes and configurations other than those shown in the attached drawings. Conductors 14 are positioned such that a relatively small amount of physical space exists between them and magnetic field generating devices 12, thereby increasing the amount of electrical current that is induced in conductors 14 when devices 12 pass by. Conductors 14 are shown attached to the outside of rails 48, although it will be understood that they can be repositioned to any suitable location that does not interfere with the proper interaction of wheels 52 on track 46.

Conductors 14 may advantageously be longitudinally positioned along track 46 at locations where it is likely that train car 40 will need to brake, or where the speed of train car 40 is desirably limited or reduced (such as, for example, when traveling down an inclined section of railroad tracks 46). Conductors 14 therefore may advantageously be placed near train stations, along declined sections of track, along sections of track where the speed limit is reduced, or in other locations. Conductors 14 may extend for a longitudinal length that is long enough for all of the train cars 40 within a train to be able to have their corresponding magnetic field generating devices 12 interact with conductors 14 for a sufficiently long enough time to allow the typical amount of braking to be achieved for the train. Thus, for example, if a particular section of railroad track includes a speed reduction from 40 to 30 miles per hour, and that section of track customarily handles trains that may extend up to a half a mile in length, one or more conductors 14 may be positioned on each of the rails 48 that extend longitudinally along the length of the track for at least a half a mile, and preferably for a greater distance. The amount of distance in excess of half a mile should be, although it is not required to be, long enough to allow the train to reduce its speed from 40 miles per hour to 30 miles per hour while utilizing the regenerative brakes. By extending conductors 14 longitudinally for this distance, it is possible to recapture virtually all of the kinetic energy of the train that is lost due to the speed reduction.

Because braking may not occur at precisely the same location for each train, it may be advantageous to position additional length of conductors 14 along the rails 48 to accommodate these differences. Also, it may be advantageous to extend conductors 14 even longer to accommodate unusually long trains. It is, however, not necessary for the length of conductors 14 to extend for the entire length of the train. In some embodiments, conductors 14 may extend for only a fraction of the length of the train, in which case regenerative braking only occurs for those train cars 40 which have their devices 12 positioned adjacent a conductor 14.

The positioning of conductors 14 along a longitudinal length of track 46 may involve positioning a series of separate conductors 14 one after another along the length of the track, or, it may alternatively involve positioning one conductor 14 along the track 46 for the entire length for which the conductor's presence is desirable. In other words, the length of individual conductors 14 may be varied in any suitable fashion. Further, regardless of length, conductors 14 may include multiple coils arranged to accumulate their collectively induced electrical current, or it may include only a single coil.

The braking action created by the interaction of devices 12 and conductors 14 may be the sole means for braking a train car 40; however, it may be advantageous to also include on train car 40 mechanical brakes in addition to devices 12. That is, train car 40 may, in addition to devices 12, include conventional mechanical brakes that frictionally retard the rotational movement of the wheels 52 (and thereby generate heat). Such conventional brakes may operate directly against the wheels, or they may operate against brake drums associates with the wheels, or against any other rotating component of the train car 40 that rotates in conjunction with the wheels. Other types of brakes besides mechanical brakes may also be used on train car 40.

Train car 40 may be configured to include one or more sensors (not shown) that detect the presence of conductor 14 alongside rails 48. Further, train car 40 may include a controller 58 (FIG. 7) that is in communication with the sensor and, if the presence of conductor 14 is detected, activates devices 12 when a control signal is received indicating that the train car is to be braked. That is, controller 58 may be configured to first utilize devices 12 in conjunction with conductors 14 when the train car is to be braked. If conductors 14 are not available, then controller 58 may be configured to implement the braking of the train car by using the secondary braking system on board the train car (such as the mechanical brakes discussed above). In this manner, controller 58 will ensure that the kinetic energy lost due to braking will be recovered wherever such recovery is possible (it is contemplated, though not required, that conductors 14 will not be positioned alongside the entire length of tracks 46, but rather, as noted above, only in those areas where the kinetic energy of the train is desirably reduced or limited, although it would be possible to position conductors 14 along the entire length of track over which the train may travel).

FIG. 7 illustrates a train 60 that may utilize one or more aspects of the energy recovery systems of the present invention. Train 60 is comprised of a locomotive 62 and two non-locomotive train cars 40. Locomotive 62 provides the motive force for moving train 60, and locomotive 62 may be a diesel-powered locomotive, an electric locomotive, or any other type of locomotive. Non-locomotive cars 40 differ from locomotive 62 in that they must be pulled by a locomotive in order to move along the railroad tracks. Locomotive 62 includes a braking control 64 that is typically activated manually by an engineer who rides aboard locomotive 62 (although it may be activated automatically in certain situations). Braking control 64 may be a conventional structure used to activate the brakes on a train, or it may be a custom-designed structure built specifically to interact with the devices 12 on board train cars 40. However constructed, braking control 64 causes the brakes aboard train 60 to be activated, thereby reducing the speed of train 60. More specifically, the brakes that are activated by braking control 64 may be either, or both, of the conventional brakes aboard the train cars 40 and the regenerative brakes of devices 12 and conductors 14, as will be explained more below.

When braking control 64 is activated, it sends a control message along a braking conduit 66 that extends to each of the train cars 40 that are pulled (or pushed) by locomotive 62. Conduit 66 may include an electrical wire, in which case the control message includes one or more electrical signals, or conduit 66 may include a pressurized air (or other fluid) line, in which case the control messages include fluid signals. Alternatively, conduit 66 may transfer a mixture of both electrical and pressurized fluid signals. While conduit 66 is illustrated in FIG. 7 as comprised of a single line, conduit 66 may include multiple lines. Conduit 66 passes through a plurality of connectors 72 that are positioned toward the ends of each train car 40. Connectors 66 may be any suitable type of connectors that allow conduit 66 to be connected and disconnected from neighboring train cars, and to communicate its control signals from one train car to another when so connected. Such connectors may include jacks, plugs, or any other suitable type of connector.

Each train car 40 may include a controller 58. Controllers 58 are in communication with conduit 66, whether the communication is fluid, electric, or otherwise. When braking control 64 is activated, it sends an appropriate braking control message through conduit 66 that is detected by controllers 58. Controllers 58 respond to the braking message by activating magnetic field generating devices 12. Such activation may take on a variety of forms. In one embodiment, magnetic field generating devices 12 include one or more coils, and the activation of devices 12 includes feeding an electrical current through the coils to thereby generate a magnetic field. In another embodiment, magnetic field generating devices 12 may be permanent magnets and the activation of devices 12 includes physically moving devices 12 to a location in which they are in closer proximity to conductors 14. In yet another embodiment, magnetic field generating devices 12 include both coils and permanent magnets, and the activation of devices 12 includes both feeding a current through the coils and physically moving devices 12 closer to conductors 14.

If constructed such that devices 12 move closer to conductors 14 upon activation, the movement of devices 12 is carried out by way of moveable arm 56. Moveable arm 56 may be constructed in any suitable manner that allows devices 12 to be moved toward and away from conductors 14. For example, moveable arm 56 may be constructed to move devices 12 toward and away from conductors 14 in a horizontal direction 68 (FIG. 6), or a vertical direction 70, or a combination of both horizontal and vertical movement. Moveable arm 56 may be powered electrically, pneumatically, or by other means. Moveable arm 56 may utilize one or more solenoids, pneumatic actuators, or other suitable actuators, for carrying out the desired physical movement of devices 12. Moveable arm 56 is illustrated in FIGS. 5 and 6 as being attached to bogie 42, but moveable arm may be attached to other portions of train car 40.

If devices 12 do not contain any permanent magnets, controller 58 may be configured to activate device 12 simply by feeding an electrical current through the coil (or coils) of device 12 without physically moving device 12. In such cases, moveable arm 56 may optionally be dispensed with.

Regardless of the construction and/or presence of moveable arm 56, the control signals transmitted from braking control 64 may include information regarding the intensity or degree to which the brakes should be activated. The particular manner in which this intensity or degree is indicated can vary in any suitable manner. For electrical communications, the intensity may be proportional to, or otherwise related to, a voltage level, or it may involve a digital signal, or it may involve other forms. For fluid communications, the intensity may be proportional, or otherwise related to, a pressure level, or it may involve other forms. Regardless of format, the intensity level communicated via the control message provides an indication of how hard the brakes should be activated. That is, the harder the brakes are activated, the more quickly the train should slow down.

In order to carry out this variable intensity braking, controller 58 may be configured such that the amount of electrical current supplied to devices 12 and/or the amount of physical movement of devices 12 is tied to the intensity specified in the control message. Stated alternatively, the higher the intensity of braking indicated in the control message, the more current controller 58 may supply to devices 12 (assuming they contain at least one coil) and the closer controller 58 may physically move devices 12 to conductors 14 (assuming devices 12 are attached to a moveable arm 56, or other means for moving them). Thus, if the train engineer wishes the train to stop as fast as possible, the intensity level indicated in the control message will be at a maximum, and controller 58 will either feed the maximum amount of current through devices 12 (to thereby create the strongest magnetic field possible), and/or it will move devices 12 to the position in which they are as close to conductors 14 as is possible (to thereby maximize the amount of magnetic flux from devices 12 that is intersected by conductors 14).

The braking carried out by devices 12 and conductors 14 may also be reversed from that described above in certain embodiments. That is, when it is desirable for the train to brake, braking control 64 could be adapted to transmit a braking signal to an off-board controller that physically moved conductors 14 into a position in which the magnetic fields of devices 12 intersected conductors 14. The amount of movement could be tied to the intensity of braking that was desired. Such movement would reduce the kinetic energy of the train through the application of Lenz's law and the increased current induced in conductors 14.

As illustrated in FIG. 7, a single controller 58 may be positioned on each train car 40 and adapted to control four or more different magnetic field generating devices 12. When controlling multiple different devices 12, the changes to each device may be carried out simultaneously, or substantially simultaneously, in order to avoid applying uneven, and potentially disruptive, forces to the train car 40. In an alternative, multiple controllers 58 may be included on a single train car 40. Controllers 58 may be constructed in a wide variety of different manners. Controllers 58 may be purely electronic devices or purely mechanical devices, or they may be a mixture of the two. If they include electronic circuitry, such circuitry may include one or more processors, discrete logic circuits, ASICs, field programmable gate arrays, memory, and/or a combination of any or all of the foregoing. If they include mechanical structures, the structure may include any suitable mechanical devices for moving devices 12 and/or controlling the electrical current passing through the coil or coils of devices 12.

As a safety mechanism, controller 58 may be configured to automatically and/or repetitively check to see if it is in communication with braking control 64. If such communication is not detected, controller 58 may be configured to automatically activate devices 12. Such automatic activation may help prevent a runaway train car 40 in situations where the train car becomes detached from the locomotive.

The types of trains to which the energy recovery principles discussed herein may be applied are not limited. While the accompanying drawings illustrate a freight train car, the principles may be applied to passenger trains, subways, elevated trains, electrical trains, diesel-powered trains, monorails, and trains having more than two rails. Further, the energy recovery principles discussed herein are not limited to any particular gauge of the railroad.

In some embodiments, conductors 14 may be placed along a section of railroad track 46 that is inclined and the kinetic energy of a train traveling down the incline may be transferred, via devices 12 and conductors 14, to energy storage device 16. The energy stored therein may then be used for assisting another train (or the same train at a later time) up the incline. The stored energy may be supplied to the assisted train by any suitable means, including a catenary located above the train, via a third (or fourth) electrified rail, via inductive coupling, or by other means. However transferred, the energy that would otherwise be lost due to braking of the descending train is able to be recaptured and used for ascension. The conductors 14 in such a situation may be applied to a single track, or they may be applied to multiple tracks within a vicinity of each other. When used in conjunction with multiple tracks, the energy recovered via conductors 14 from the descending train may be transferred to an ascending train on one of the neighboring tracks that is ascending at the same time the first train is descending. In such a situation, the energy recovery system acts as an electrical version of a funicular train system whereby energy from the descending train is transferred to energy of the ascending train. It is not necessary, however, that the energy recovered during the first train's descent be immediately used for assisting another ascending train. Instead, the energy may be stored in any suitable means and used at a later time for assisting the ascending train (which may, as noted, be the first train making a later return trip on the same track, although it may also be a different train).

As was noted above, train cars 40 that are equipped with magnetic field generating devices 12 may also include conventional brakes that are activated by either braking control 64, or by other means. When so included, controllers 58 may be configured to determine whether a conductor 14 is positioned adjacent the train car when the brakes are activated. If so, controller 58 may first activate device 12 prior to activating the conventional brakes. Indeed, when a conductor 14 is nearby controller 58 may be configured to only activate the conventional brakes if the braking intensity exceeds a predefined threshold level. In that manner, most of the kinetic energy of the train car 40 can be recovered except in cases of hard braking. In such cases of hard braking, both the conventional brakes and devices 12 (in conjunction with conductors 14) will act to retard the movement of train car 40. If train car 40 is not positioned adjacent a conductor 14, controller 58 activates the conventional brakes when any braking signal is received, regardless of intensity.

In some embodiments, the decision as to whether to brake the train using conventional brakes or devices 12 in conjunction with conductors 14 may be carried out by a centralized controller located on board the locomotive 62. In such cases, there may be separate conduits 66 for the conventional brakes and the devices 12. Further, in such cases, the individual controllers 58 on each car would not need to be responsible for deciding which brakes to activate, but would simply respond to control signals indicating what braking action to take. Indeed, when the decision of which brakes to activate is made via a centralized controller located on the locomotive 62, the signal to activate the conventional brakes may travel via an entirely different conduit separate from conduit 66. In such a case, controllers 58 may not be responsible at all for activating the conventional brakes on board the train car 40.

While energy recovery system 10 has been described above primarily as generating electrical energy off-board the vehicle in conductors 14, some embodiments of system 10 include the generation of electrical energy on-board the vehicle. For example, in one embodiment, a non-locomotive train car 40 includes regenerative brakes that generate electricity on-board the non-locomotive train car 40. Such energy may be transferred to different train cars within the train and consumed on-board with any excess energy preferably stored. The stored energy may then be transferred off of the train in any suitable manner for later use by other trains, or for other uses. By including prior regenerative brakes on non-locomotive train cars, it is possible to recover a substantially larger fraction of the kinetic energy of the train than is recovered in prior art locomotives that use regenerative braking because such regenerative braking is limited to only the locomotive. Thus, the braking of the non-locomotive cars in such prior art systems ends up wasting much of the kinetic energy associated with the non-locomotive cars. At least one embodiment of energy recovery system 10 recaptures this energy by converting it to electrical energy on-board the train, while other embodiments recapture it by converting it to electrical energy off-board the train. Thus, some embodiments of the energy recovery system may include regenerative brakes that include a first portion (the stator 14) that is positioned off-board the vehicle (train car 40) and a second portion (the rotor 12) that is positioned on-board the vehicle, while other embodiments may include both portions on-board the train.

While several forms of the invention have been shown and described, other forms will now be apparent to those skilled in the art. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

I claim:

1. A train system comprising:
a track having a rail;
a coil positioned adjacent said rail;
a non-locomotive train car;
a device attached to said train car and adapted to generate a magnetic field; and
a controller adapted to activate said device such that the magnetic field generated by said device intersects with said coil and induces a voltage in said coil thereby converting a portion of the train car's kinetic energy to electrical current that flows through said coil.

2. The system of claim 1 further including:
a second coil; and
a second device attached to said train car and adapted to generate a second magnetic field, said second device adapted to be activated by said controller such that the second magnetic field intersects with said second coil and induces a voltage in said second coil thereby converting a portion of the train car's kinetic energy to electrical current that flows through said second coil.

3. The system of claim 2 wherein said track includes a plurality of rails and said coil is positioned adjacent a first one of said rails and said second coil is positioned adjacent a second one of said rails.

4. The system of claim 3 wherein said train car includes a connector in communication with said controller whereby said controller may receive a control signal through said connector indicating when said controller should activate said device and said second device, said connector being adapted to couple with an associated connector on an adjacent train car.

5. The system of claim 4 wherein said control signal indicates a degree to which said device and said second device should be activated.

6. The system of claim 5 wherein said controller responds to control signals of increasing degrees in at least one of the following manners:
(a) said controller physically moves said device and said second device to positions nearer and nearer to said coil and said second coil, respectively; and
(b) said controller increases an electrical current flowing through a first conductor that is included within said device and a second conductor that is included within said second device.

7. The system of claim 1 wherein said coil is coupled to an energy storage device that stores said electrical energy for later use.

8. The system of claim 1 wherein said track is positioned on an incline and said energy storage device is adapted to transfer said electrical energy to another train car positioned on another track, said another train car moving in an opposite direction to said train car.

9. The system of claim 8 wherein said energy storage device supplies said electrical energy to an electrolysis system for generating hydrogen from water.

10. A method of recovering energy from a train comprising:
generating a magnetic field on board a non-locomotive car of a train;
locating a conductor off-board the train along the pathway of the train; and
passing the magnetic field by the coil to induce a voltage in the conductor and thereby converting a portion of the train's kinetic energy to electrical current that flows through the conductor.

11. The method of claim 10 further including coupling the conductor to an energy storage device.

12. The method of claim 10 wherein said locating includes locating the conductor adjacent a track along which the train rides.

13. The method of claim 12, wherein said locating a conductor comprises locating a first conductor, further comprising:
locating a second conductor off-board the train;
generating a second magnetic field on board the train; and
passing the second magnetic field by the second conductor whereby the second magnetic field generates a voltage in the second conductor thereby converting a portion of the train's kinetic energy to electrical current that flows through the second conductor.

14. The method of claim 13, wherein said locating a second conductor includes locating the second conductor adjacent the track along which the train rides.

15. The method of claim 14, wherein said locating a first conductor includes locating the first conductor adjacent a first rail of the track, and said locating a second conductor includes locating the second conductor adjacent a second rail of the track.

16. The method of claim 10 further including locating the conductor adjacent in an area of the track where the track declines or where the train often slows down or stops.

17. The method of claim 16 wherein said locating includes positioning the conductor adjacent an area of the track wherein the track declines, and further comprising transmitting the electrical energy generated in the conductor to a second train on a second inclined track such that the second train uses the electrical energy to help move the second train up the inclined track.

18. The method of claim 10, further comprising controlling the magnetic field.

19. The method of claim 18, further comprising detecting when the train is in proximity to the conductor and triggering said controlling in response to said detecting.

20. The method of claim 10, further comprising selectively moving the magnetic field closer to the conductor.
